(19) United States
(12) Patent Application Publication
(10) Pub. No.: US 2025/0180434 A1
(43) Pub. Date: Jun. 5, 2025

(54) PRE-IGNITION DETECTION DEVICE

(71) Applicant: TOYOTA JIDOSHA KABUSHIKI KAISHA, Toyota-shi (JP)

(72) Inventors: Atsushi MORIKAWA, Toyota-shi (JP); Akihiro KATAYAMA, Toyota-shi (JP); Masanori TOYA, Inazawa-shi (JP)

(21) Appl. No.: 18/926,249

(22) Filed: Oct. 24, 2024

(30) Foreign Application Priority Data
Dec. 5, 2023 (JP) 2023-205275

(51) Int. Cl. G01M 15/05

(52) U.S. Cl. CPC G01M 15/05

(57) ABSTRACT

A pre-ignition detection device is provided. Processing circuitry calculates a rotation fluctuation amount of an engine and a self-ignition start timing to detect occurrence of pre-ignition in the engine. The engine is a spark-ignition engine that ignites air-fuel mixture in a combustion chamber through spark discharge. The self-ignition start timing is when a temperature of the air-fuel mixture in the combustion chamber during a compression stroke reaches an ignition point of the air-fuel mixture. It is determined that the pre-ignition in the engine has occurred when the rotation fluctuation amount is greater than or equal to a predetermined threshold value and the self-ignition start timing is earlier than a predetermined timing.

### CROSS-REFERENCE TO RELATED APPLICATIONS

This application is based upon and claims the benefit of priority from prior Japanese Patent Application No. 2023-205275, filed on Dec. 5, 2023, the entire contents of which are incorporated herein by reference.

### 1. FIELD

The present disclosure relates to a pre-ignition detection device. The pre-ignition detection device detects the occurrence of pre-ignition in a spark-ignition engine.

### 2. DESCRIPTION OF RELATED ART

A spark-ignition engine ignites the air-fuel mixture in the combustion chamber through spark discharge. In a spark-ignition engine, pre-ignition may occur. Pre-ignition is a phenomenon where the air-fuel mixture in the combustion chamber ignites spontaneously before the spark discharge is executed. Japanese Laid-Open Patent Publication No. 2009-275663 discloses a device that detects the occurrence of pre-ignition based on the rotation fluctuation amount of the engine.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides a pre-ignition detection device including processing circuitry. The processing circuitry calculates a rotation fluctuation amount of an engine and a self-ignition start timing to detect occurrence of pre-ignition in the engine. The engine is a spark-ignition engine that ignites air-fuel mixture in a combustion chamber through spark discharge. The self-ignition start timing is when a temperature of the air-fuel mixture in the combustion chamber during a compression stroke reaches an ignition point of the air-fuel mixture. The processing circuitry determines that the pre-ignition in the engine has occurred when the rotation fluctuation amount is greater than or equal to a predetermined threshold value and the self-ignition start timing is earlier than a predetermined timing.

The pre-ignition detection device improves the accuracy of detecting pre-ignition in a spark-ignition engine.

Engine rotation fluctuation may occur due to combustion failure other than pre-ignition. By relying solely on detecting pre-ignition based on the rotation fluctuation amount, there is a risk of falsely detecting pre-ignition when other types of combustion failure occur. The above-described configuration eliminates this problem.

Other features and aspects will be apparent from the following detailed description, the drawings, and the claims.

### BRIEF DESCRIPTION OF THE DRAWINGS

FIG. 1 is a schematic diagram showing a pre-ignition detection device according to an embodiment.

FIG. 2 is a flowchart of the pre-ignition detection routine executed by the processor of the pre-ignition detection device shown in FIG. 1.

FIG. 3 is a timing diagram, where section (A) shows changes in the rotation speed of the crankshaft of the engine shown in FIG. 1 and section (B) shows changes in the angular velocity of the crankshaft.

FIG. 4 is a graph showing changes in the in-cylinder pressure during normal combustion and during the occurrence of pre-ignition in a gasoline engine.

FIG. 5 is a graph showing changes in the in-cylinder pressure during normal combustion and during the occurrence of pre-ignition in a hydrogen engine.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

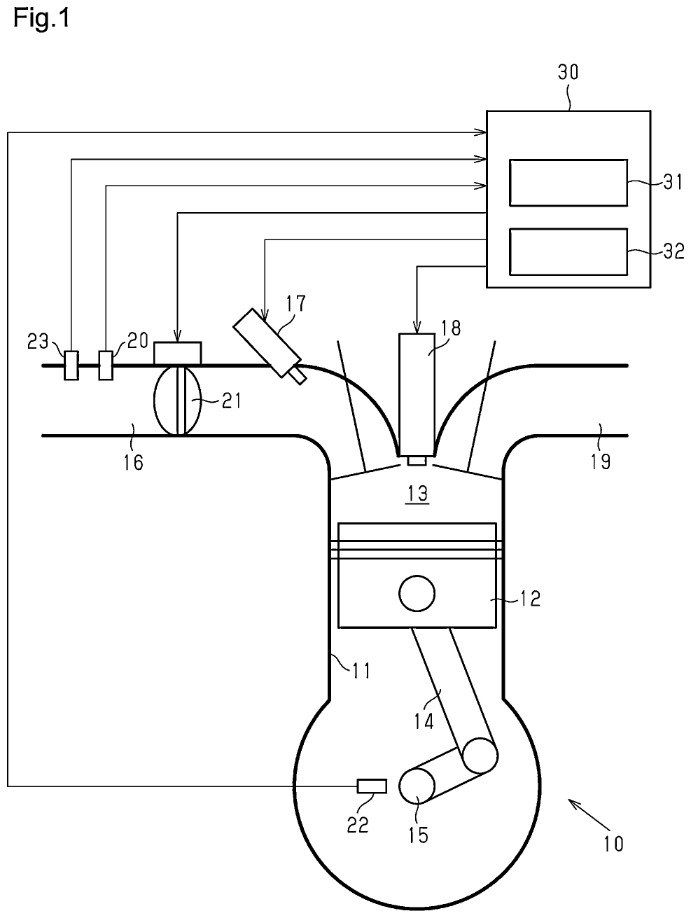

The following describes an embodiment of a pre-ignition detection device in detail with reference to FIGS. 1 to 5.

### Configuration of Engine 10

First, the configuration of an engine 10, in which the pre-ignition detection device of the present embodiment is employed, will be described with reference to FIG. 1. The engine 10 shown in FIG. 1 is a hydrogen engine, and its fuel is hydrogen. The engine 10 includes a cylinder 11 and a piston 12, which is reciprocally housed within the cylinder 11. A combustion chamber 13, in which air-fuel mixture burns, is defined in the cylinder 11 by the piston 12. The piston 12 is coupled to a crankshaft 15, which is an output shaft of the engine 10, by a connecting rod 14. The connecting rod 14 and the crankshaft 15 are included in a crank mechanism that converts reciprocating motion of the piston 12 into rotational motion of the crankshaft 15. Additionally, the engine 10 includes an intake passage 16, an injector 17, an ignition device 18, and an exhaust passage 19. An air-fuel mixture of intake air flowing through the intake passage 16 and hydrogen injected by the injector 17 is drawn into the combustion chamber 13. The air-fuel mixture inside the combustion chamber 13 is ignited by the spark discharge generated by an ignition device 18. Exhaust gas generated by the combustion of the air-fuel mixture is discharged from the combustion chamber 13 through the exhaust passage 19. The intake passage 16 includes an air flow meter 20 that detects an intake air flow rate GA of the intake passage 16, and a throttle valve 21 that adjusts the intake air flow rate GA.

### Configuration of Pre-Ignition Detection Device

The configuration of the pre-ignition detection device of the present embodiment will now be described with reference to FIG. 1. In the present embodiment, the pre-ignition detection device includes an electronic control unit (ECU) 30 used for engine control. The ECU 30 receives detection signals from various sensors that detect the operating state of the engine 10. Examples of such sensors include the aforementioned air flow meter 20, a crank angle sensor 22 that detects the crank angle, which is the rotation angle of the crankshaft 15, and an intake air temperature sensor 23 that detects an intake air temperature THA in the intake passage 16. The ECU 30 includes a processor 31 and a memory 32. The memory 32 stores programs and data for engine control in advance. The processor 31 executes a program read from the memory 32 to respectively calculate the operation amounts of the engine 10 based on the detection results from the sensors. The processor 31 is a processing device or processing circuitry. Examples of the operation amounts of the engine 10 executed by the processor 31 include the amount and timing of hydrogen injected by the injector 17, the ignition timing of the air-fuel mixture by the spark discharge of the ignition device 18, and the opening degree of the throttle valve 21. The ECU 30 controls the operating state of the engine 10 by adjusting the injector 17, the ignition device 18, the throttle valve 21, and the like based on the operation amounts calculated by the processor 31.

### Pre-Ignition Detection Process

In the engine 10, pre-ignition may occur. In pre-ignition, combustion begins with the air-fuel mixture in the combustion chamber 13 undergoing self-ignition before the ignition device 18 initiates spark discharge. The ECU 30 detects the occurrence of pre-ignition in the engine 10. The pre-ignition detection process executed by the ECU 30 will now be described in detail. The pre-ignition detection process is performed by the processor 31 executing pre-ignition detection programs read from the memory 32. In the following description, normal combustion refers to the following conditions. During normal combustion, pre-ignition does not occur. Further, during normal combustion, the ignition device 18 initiates the combustion of the air-fuel mixture within the combustion chamber 13 through spark discharge.

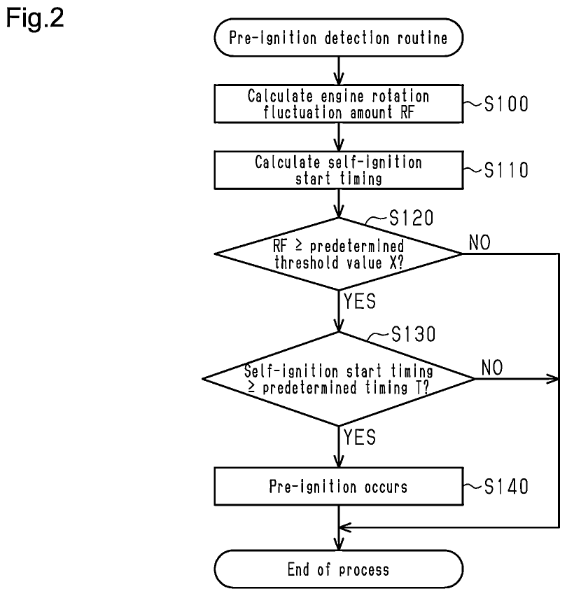

FIG. 2 shows the procedure of a pre-ignition detection routine executed by the processor 31 for the pre-ignition detection process. The processor 31 repeatedly executes the same routine at predetermined control cycles while the engine 10 is running.

The processor 31, upon initiating this routine, first calculates a rotation fluctuation amount RF of the engine 10 (S100). The processor 31 calculates the engine rotation speed NE based on the detection results from the crank angle sensor 22. The processor 31 calculates the angular velocity of the crankshaft 15 by determining the differentiated value of the engine rotation speed NE. The processor 31 calculates the absolute value of the minimum value of the angular velocity for each combustion cycle or calculates the variation range of the angular velocity for each combustion cycle, as the value of the rotation fluctuation amount RF.

Next, the processor 31 calculates a self-ignition start timing (S110). The self-ignition start timing is when the temperature of the air-fuel mixture in the combustion chamber 13 during the compression stroke reaches the ignition point of the air-fuel mixture. In the present embodiment, the ignition point of the air-fuel mixture is the ignition point of hydrogen. The self-ignition start timing is expressed by the crank angle before compression top dead center [BTDC°]. The processor 31 calculates the intake air amount of the combustion chamber 13 based on parameters such as the intake air flow rate GA, the engine rotation speed NE, and the opening degree of the throttle valve 21. The processor 31 calculates the self-ignition start timing based on the intake air amount and the intake air temperature THA.

The present embodiment calculates the self-ignition start timing under the assumption that the air-fuel mixture in the combustion chamber 13 undergoes adiabatic compression during the compression stroke. The volume of the combustion chamber 13 at the moment when the air-fuel mixture undergoes adiabatic compression and reaches its ignition point can be calculated using Poisson's law and the first law of thermodynamics. Specifically, the volume of the combustion chamber 13 can be calculated based on the volume of the combustion chamber 13 at the start of the compression stroke, the intake air amount, the intake air temperature THA, and the specific heat ratio of the air-fuel mixture, among other factors. The volume of the combustion chamber 13 is determined by the crank angle. These relationships are used to calculate the timing [BTDC°] when the volume of the combustion chamber 13 reaches the calculated value. The self-ignition start timing is thus obtained.

When the following requirement A and requirement B are satisfied (S120: YES and S130: YES), the processor 31 determines that pre-ignition has occurred (S140). Requirement A is that the rotation fluctuation amount RF calculated in S100 is greater than or equal to a predetermined threshold value X. The predetermined threshold value X is set to a value greater than the maximum allowable rotation fluctuation amount. The maximum allowable rotation fluctuation amount is the maximum value of the rotation fluctuation amount RF during normal combustion. Requirement B is that the self-ignition start timing calculated in S110 is earlier than a predetermined timing T. The predetermined timing T is set to be earlier than the optimal ignition timing. The torque generated by the engine 10 varies depending on the ignition timing. At the optimal ignition timing, the torque generated by the engine 10 reaches its maximum. The ECU 30 controls the ignition timing of the air-fuel mixture, ignited by the spark discharge of the ignition device 18, to the optimal ignition timing or a later timing. Thus, regardless of the control state of the engine 10, the predetermined timing T is earlier than the timing when ignition is performed by the ignition device 18. The processor 31 terminates the processes of this routine for the current control cycle after determining that pre-ignition has occurred in S140 or after a negative determination is made in either S120 or S130.

When the processor 31 determines that pre-ignition has occurred in this routine, the processor 31 will perform adjustments to the operation amounts of the engine 10 to limit the occurrence of pre-ignition. Examples of the adjustments of the operation amounts to limit the occurrence of pre-ignition include reduction in the opening degree of the throttle valve 21. As the opening degree of the throttle valve 21 decreases, the intake air amount of the combustion chamber 13 decreases. This limits the rise in the temperature of the air-fuel mixture inside the combustion chamber 13 due to adiabatic compression during the compression stroke. Accordingly, the occurrence of pre-ignition is limited.

### Operation and Advantages of Embodiment

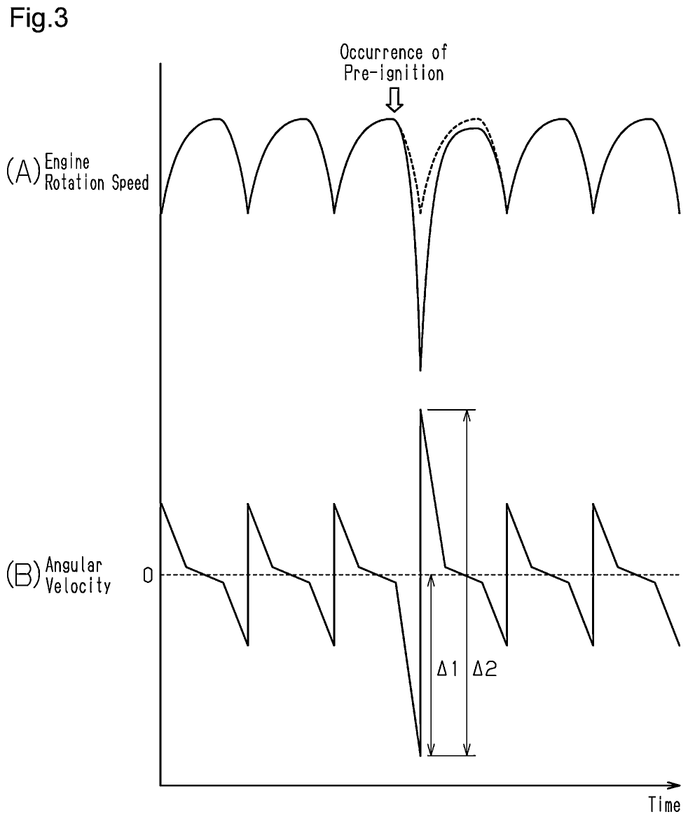

Section (A) of FIG. 3 shows changes in the engine rotation speed NE during the period before and after the occurrence of pre-ignition. Section (B) of FIG. 3 shows changes in the angular velocity of the crankshaft 15 during that period.

The combustion pressure resulting from the ignition of the air-fuel mixture within the combustion chamber 13 is exerted on the top surface of the piston 12. As a result, the engine rotation speed NE increases. The engine rotation speed NE decreases after reaching its peak until the next combustion occurs. Thus, the engine rotation speed NE repeatedly increases and decreases with each combustion.

When pre-ignition occurs, it hinders the upward movement of the piston 12 within the cylinder 11 during the compression stroke. Thus, the engine rotation speed NE decreases. Accordingly, when pre-ignition occurs, the engine rotation speed NE decreases more significantly compared to the engine rotation speed NE during normal combustion. As a result, the rotation fluctuation amount RF of the engine 10 increases. The maximum allowable rotation fluctuation amount is the maximum value of the rotation fluctuation amount RF during normal combustion. Accordingly, when the rotation fluctuation amount of the engine 10 exceeds the maximum allowable rotation fluctuation amount, there is a possibility that pre-ignition has occurred.

In the present embodiment, the processor 31 calculates the rotation fluctuation amount RF of the engine 10 in the pre-ignition detection routine shown in FIG. 2 (S100). The processor 31 includes the condition that the rotation fluctuation amount RF being greater than or equal to the predetermined threshold value X, as one of the requirements for determining that pre-ignition has occurred. The processor 31 determines whether the rotation fluctuation amount RF of the engine 10 is greater than or equal to the threshold value X, based on the angular velocity of the crankshaft 15. Specifically, the processor 31 calculates either the absolute value of the minimum angular velocity per combustion cycle of the engine 10 or the range of variations in the angular velocity per combustion cycle of the engine 10 as the rotation fluctuation amount value RF of the engine 10. In section (B) of FIG. 3, 41 represents the absolute value of the minimum angular velocity during the occurrence of pre-ignition. In section (B) of FIG. 3, 42 represents the range of variations in the angular velocity during the occurrence of pre-ignition.

When combustion failure other than pre-ignition (e.g., misfire) occurs, the engine rotation speed NE decreases in the same manner as pre-ignition. Thus, relying solely on the rotation fluctuation amount RF of the engine 10 may sometimes make it difficult to distinguish between pre-ignition and other types of combustion failure.

The conditions for the pre-ignition occurrence include that the temperature of the air-fuel mixture inside the combustion chamber 13 exceeds the ignition point due to adiabatic compression during the compression stroke. When pre-ignition occurs relatively near compression top dead center of compression, the decrease in the engine rotation speed NE is smaller compared to when pre-ignition occurs at an earlier timing. Thus, even if the rotation fluctuation of the engine 10 occurs, when the temperature of the air-fuel mixture reaches the ignition point after the ignition timing, it is considered that the cause of the rotation fluctuation amount of the engine 10 is not pre-ignition.

In the present embodiment, the processor 31 calculates the self-ignition start timing in the pre-ignition detection routine shown in FIG. 2. At the self-ignition start timing, the temperature of the air-fuel mixture within the combustion chamber 13 during the compression stroke reaches the ignition point of the air-fuel mixture. The processor 31 determines that pre-ignition has occurred when the rotation fluctuation amount RF is greater than or equal to the threshold value X and the self-ignition timing is earlier than the specified timing T. Thus, for example, compared to a method that determines the occurrence of pre-ignition based solely on the rotation fluctuation amount RF, the present embodiment has a lower likelihood of erroneously determining other types of combustion failures as pre-ignition. Accordingly, the pre-ignition detection device of the present embodiment improves the accuracy of detecting pre-ignition.

The pre-ignition detection device in the present embodiment can also be employed in gasoline engines, that is, to spark-ignition engines other than hydrogen engines. In general, in hydrogen engines, it is more difficult to distinguish between pre-ignition and other types of combustion failure than in gasoline engines. Thus, the pre-ignition detection device of the present embodiment is particularly suitable for application to hydrogen engines.

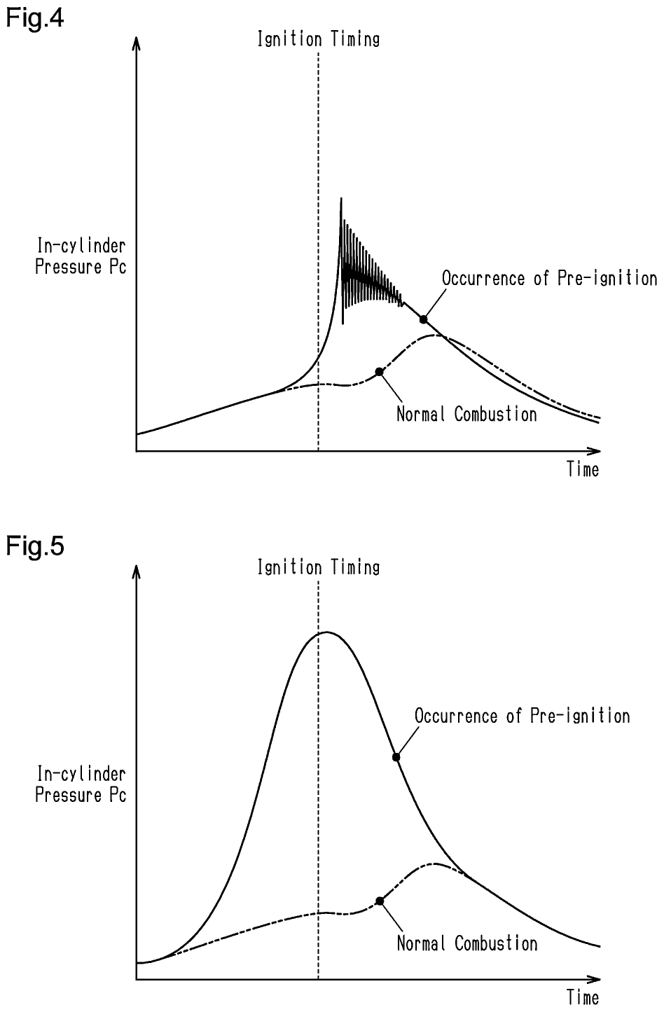

FIG. 4 shows changes in the in-cylinder pressure Pc during normal combustion and during the occurrence of pre-ignition in a gasoline engine. The long dashed double-short dashed line indicates the in-cylinder pressure Pc during normal combustion. The solid line indicates the in-cylinder pressure Pc during pre-ignition. The in-cylinder pressure Pc represents the pressure within the combustion chamber 13. As shown in FIG. 4, when pre-ignition occurs, the in-cylinder pressure Pc rises sharply. For the gasoline engine, when the air-fuel mixture self-ignites, unlike during normal combustion, flame propagation within the combustion chamber 13 does not progress smoothly. As a result, after the occurrence of pre-ignition, the in-cylinder pressure Pc fluctuates abruptly. The fluctuation in the in-cylinder pressure Pc during such pre-ignition occurrence can be detected by, for example, a knock sensor designed for knocking detection. In combustion failure other than pre-ignition, such fluctuations in the in-cylinder pressure Pc do not occur. Most gasoline engines include a knock sensor. In other words, for gasoline engines, by referencing both the rotation fluctuation amount RF and the detection results from the knock sensor, it is possible to distinguish between pre-ignition and other types of combustion failure.

FIG. 5 shows changes in the in-cylinder pressure Pc during normal combustion and during the occurrence of pre-ignition in a hydrogen engine. The long dashed double-short dashed line indicates the in-cylinder pressure Pc during normal combustion. The solid line indicates the in-cylinder pressure Pc during pre-ignition. The ignition point of hydrogen is higher than that of gasoline. The propagation speed of a hydrogen flame is higher than that of a gasoline flame. Thus, in the hydrogen engine, the in-cylinder pressure Pc rises earlier and more sharply during pre-ignition compared to the gasoline engine. In the hydrogen engine, after pre-ignition occurs, the flame propagates throughout the entire combustion chamber 13 faster than the gasoline engine. As a result, unlike in the gasoline engine, significant fluctuations in the in-cylinder pressure Pc are less likely to occur after pre-ignition occurs in the hydrogen engine. Consequently, in the hydrogen engine, the detection results from the knock sensor cannot be used as supporting evidence for the occurrence of pre-ignition. Therefore, distinguishing between pre-ignition and other types of combustion failure in the hydrogen engine is more difficult than in the gasoline engine.

The pre-ignition detection device of the present embodiment provides the following advantages.
(1) The processor 31 detects the occurrence of pre-ignition through the following two processes. One of the two processes calculates the rotation fluctuation amount RF of the engine 10 and the self-ignition start timing. The other one determines that pre-ignition has occurred when the rotation fluctuation amount RF is greater than or equal to the predetermined threshold value X and the self-ignition start timing is earlier than the predetermined timing T. At the self-ignition start timing, the temperature of the air-fuel mixture within the combustion chamber 13 during the compression stroke reaches the ignition point of the air-fuel mixture. Pre-ignition occurs after the self-ignition start timing. In addition, when pre-ignition occurs at a later timing, the rotation fluctuation of the engine 10 is smaller compared to when pre-ignition occurs at an earlier timing. Thus, pre-ignition accompanied by significant engine rotation speed fluctuations occurs when the self-ignition start timing is earlier than a certain threshold value. Therefore, by referencing both the rotation fluctuation amount RF and the self-ignition start timing, it may be possible to distinguish between pre-ignition and other types of combustion failures. Accordingly, the pre-ignition detection device of the present embodiment improves the accuracy of detecting pre-ignition.
(2) The processor 31 calculates the self-ignition start timing based on the intake air amount of the combustion chamber 13 and the intake air temperature THA. The intake air amount and intake air temperature THA are the primary factors used to determine the self-ignition start timing. This enhances the accuracy of calculating the self-ignition start timing, thereby improving the accuracy of detecting pre-ignition.
(3) The processor 31 determines whether the rotation fluctuation amount RF is greater than or equal to the predetermined threshold value X based on the angular velocity of the crankshaft 15 of the engine 10. This enhances the accuracy of determining whether the rotation fluctuation amount RF is greater than or equal to the predetermined threshold value X, thereby improving the accuracy of detecting pre-ignition.
(4) In general, in hydrogen engines, it is more difficult to distinguish between pre-ignition and other types of combustion failure than in gasoline engines. The present embodiment allows for accurate detection of pre-ignition even in hydrogen engines.

### Modifications

The present embodiment may be modified as follows. The present embodiment and the following modifications can be combined as long as the combined modifications remain technically consistent with each other.

The rotation fluctuation amount quantity RF calculated by the ECU 30 may be a different physical quantity other than that of the above-described embodiment. The rotation fluctuation amount RF may be any physical quantity that represents the magnitude of the rotation fluctuation amount of the engine 10, such as the variation range of the engine rotation speed NE during each combustion cycle.

Methods different from those in the above-described embodiment may be used to calculate the self-ignition start timing. In addition to the intake air amount and the intake air temperature THA, factors such as the amount of hydrogen injection and the wall surface temperature of the cylinder 11 may also be used to determine the self-ignition start timing. By performing calculations based on those factors, the calculation accuracy of the self-ignition start timing is improved. Additionally, the self-ignition start timing may be calculated without using either the intake air amount or the intake air temperature THA.

The pre-ignition detection device in the above-described embodiment may also be employed in gasoline engines, that is, to spark-ignition engines using fuels other than hydrogen.

The pre-ignition detection device may be a device that includes a CPU and a ROM and executes software processing. That is, the pre-ignition detection device may be processing circuitry that has any one of the following configurations (a) to (c).
(a) The pre-ignition detection device includes one or more processors that execute various processes in accordance with a computer program. The processor includes a CPU and a memory, such as a RAM and ROM. The memory stores program codes or instructions configured to cause the CPU to execute the processes. The memory, or a non-transitory computer-readable storage medium, includes any type of media that are accessible by general-purpose computers and dedicated computers.
(b) The pre-ignition detection device includes one or more dedicated hardware circuits that execute various processes. Examples of the dedicated hardware circuits include an application-specific integrated circuit (ASIC) and a field-programmable gate array (FPGA).
(c) The pre-ignition detection device includes a processor that executes part of various processes in accordance with a computer program and a dedicated hardware circuit that executes the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A pre-ignition detection device comprising processing circuitry configured to execute:
calculating a rotation fluctuation amount of an engine and a self-ignition start timing, wherein the engine is a spark-ignition engine that ignites air-fuel mixture in a combustion chamber through spark discharge, and the self-ignition start timing is when a temperature of the air-fuel mixture in the combustion chamber during a compression stroke reaches an ignition point of the air-fuel mixture; and
detecting occurrence of pre-ignition in the engine by determining that the pre-ignition in the engine has occurred when the rotation fluctuation amount is greater than or equal to a predetermined threshold value and the self-ignition start timing is earlier than a predetermined timing.

2. The pre-ignition detection device according to claim 1, wherein
fuel for the engine is hydrogen.

3. The pre-ignition detection device according to claim 1, wherein
the processing circuitry is configured to calculate the self-ignition start timing based on an intake air amount of the combustion chamber.

4. The pre-ignition detection device according to claim 1, wherein
the processing circuitry is configured to calculate the self-ignition start timing based on a temperature of intake air drawn into the combustion chamber.

5. The pre-ignition detection device according to claim 1, wherein
the processing circuitry is configured to determine whether the rotation fluctuation amount is greater than or equal to the predetermined threshold value based on an angular velocity of a crankshaft of the engine.
